(19) United States
(12) Patent Application Publication
(10) Pub. No.: US 2009/0283205 A1
(43) Pub. Date: Nov. 19, 2009

(54) METHOD OF MANUFACTURING A THIN-FILM MAGNETIC HEAD

(75) Inventors: Hiroyuki Miyazawa, Kawasaki (JP); Masaya Kato, Kawasaki (JP); Masanori Tachibana, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/354,519

(22) Filed: Jan. 15, 2009

(30) Foreign Application Priority Data
May 16, 2008 (JP) 2008-129338

(51) Int. Cl. B32B 37/02

(52) U.S. Cl. 156/154

(57) ABSTRACT

A method of manufacturing a thin-film magnetic head is capable of planarizing and forming the upper surface of a main magnetic pole with high precision, of forming a trailing gap with a precise form, and of efficiently and precisely forming side shields and a trailing shield. A stopper layer is formed so as to cover a magnetic pole and so that a thickness thereof at positions on both sides of the magnetic pole is a predetermined side shield gap width. After a resist layer has been formed so that a thickness thereof at positions on both sides of the magnetic pole is a predetermined side shield width, an insulating layer is formed thereupon and then lapping according to a CMP process is carried out until the stopper layer becomes exposed. After this, the stopper layer is removed by dry etching until the upper surface of the magnetic pole becomes exposed, and then the upper surface of the magnetic pole is lapped by a CMP process until the surface is planarized. Next, the resist layer is removed and the stopper layer that becomes exposed due to such removal is also removed to form the trailing shield and the side shields.

### BACKGROUND OF THE INVENTION

1. Field of the Invention

The present invention relates to a method of manufacturing a thin film magnetic head and in more detail to a method of manufacturing a thin film magnetic head including a recording head unit that is formed by successively laminating predetermined thin films on a substrate.

2. Background Art

The storage capacity of storage apparatuses such as magnetic disk apparatuses has been increasing prominently in recent years. This has led to demand for increases in the recording density of recording media and further improvements in the recording/reproducing characteristics of magnetic heads. For example, magnetic heads have been developed that use a magnetoresistance reproduction element, such as a GMR (Giant Magneto Resistance) element that is capable of achieving a high reproduction output or a TMR (Tunneling Magneto Resistance) element that can achieve a higher reproduction sensitivity, as a reproduction head. On the other hand, inductive heads that use electromagnetic induction are being developed as recording heads.

In a storage apparatus that carries out perpendicular recording, or in other words uses a combination of a perpendicular magnetic recording medium and a perpendicular magnetic recording head, since the track width is reduced to achieve a high recording density, there is the problem of how to prevent a magnetic field from leaking onto an adjacent recording track and unintentionally recording data (a phenomenon called “side erasing”). To address such problem, a method that provides trailing and side shields around the main magnetic pole and precisely sets the gap length on the trailing side has been proposed (see Patent Document 1).
Patent Document 1

Japanese Laid-Open Patent Publication No. 2007-250074

### SUMMARY OF THE INVENTION

The following method is known as one example of a method of manufacturing a thin film magnetic head (recording head) where side shields are disposed at an arbitrary distance on both sides of an inversely trapezoidal main magnetic pole and the main magnetic pole is equipped with a trailing shield with a narrow gap on the trailing side. First, a non-magnetic layer is formed after the main magnetic pole has been formed in an inversely trapezoidal shape and then a trailing (side) shield that also serves as the side shields is formed by plating or the like. However, when such plating is carried out by a resist reflow process (described in detail later), the upper surface of the main magnetic pole will become curved due to the plating, and therefore there has been the problem that it is not possible to planarize the upper surface of the main magnetic pole with the method described above.

The present invention has an object of providing a method of manufacturing a thin film magnetic head that makes it possible to planarize and form the upper surface of a main magnetic pole with high precision, to form the trailing gap with a highly precise form, and to form side shields and a trailing shield efficiently and with high precision.

To achieve the stated object, a method of manufacturing a thin-film magnetic head according to the present invention includes: a step of forming a recording magnetic pole by successively laminating thin films on a substrate; a step of forming a stopper layer so as to cover the magnetic pole and so that a thickness of the stopper layer at positions on both sides of the magnetic pole is a predetermined side shield gap width; a step of forming a resist layer so as to cover the stopper layer around the magnetic pole and so that a thickness of the resist layer at positions on both sides of the magnetic pole is a predetermined side shield width; a step of forming an insulating layer so as to cover the resist layer; a step of lapping the insulating layer and the resist layer by a CMP (Chemical Mechanical Polishing) process until an upper surface of the stopper layer is exposed; a step of removing the stopper layer by dry etching using reactive gas until an upper surface of the magnetic pole is exposed; a step of lapping the upper surface of the magnetic pole by a CMP process until the upper surface is planarized; a step of removing the resist layer by etching; a step of removing the stopper layer by dry etching using reactive gas at positions where the stopper layer has become exposed due to removal of the resist layer; a step of forming a trailing gap layer on the upper surface of the magnetic pole; a step of forming a trailing shield on the upper surface of the magnetic pole and side shields on both sides of the magnetic pole by plating; and a step of lapping by a CMP process until an upper surface of the trailing shield is a predetermined height.

Note that the stopper layer can be favorably constructed using one of tantalum and ruthenium. Also, a RIE process can be favorably used as the dry etching using the reactive gas, and a plasma etching process that uses oxygen can be favorably used as the step of removing the resist layer by etching.

According to the present invention, it is possible to planarize the upper surface of the main magnetic pole of a thin-film magnetic head while using plating according to a resist reflow process. In addition, it is possible to form the side shields and the trailing shield that surround the main magnetic pole efficiently and with high precision.

Furthermore, it is possible to easily form the side shields in an optimal form for preventing side erasing, and to form the trailing gap with high precision.

### BRIEF DESCRIPTION OF THE DRAWINGS

FIG. 1 is a schematic diagram showing one example of the construction of a thin-film magnetic head manufactured by a method of manufacturing a thin-film magnetic head according to an embodiment of the present invention;

FIGS. 2A to 2D are diagrams useful in explaining the method of manufacturing a thin-film magnetic head according to an embodiment of the present invention;

FIGS. 3A to 3D are diagrams useful in explaining the method of manufacturing a thin-film magnetic head according to an embodiment of the present invention;

FIGS. 4A to 4D are diagrams useful in explaining the method of manufacturing a thin-film magnetic head according to an embodiment of the present invention;

FIG. 5 is a diagram useful in explaining the method of manufacturing a thin-film magnetic head according to an embodiment of the present invention; and

FIG. 6 is a plan view (schematic diagram) of a thin-film magnetic head at an intermediate stage during the method of manufacturing a thin-film magnetic head according to an embodiment of the present invention.

### DESCRIPTION OF THE PREFERRED EMBODIMENT

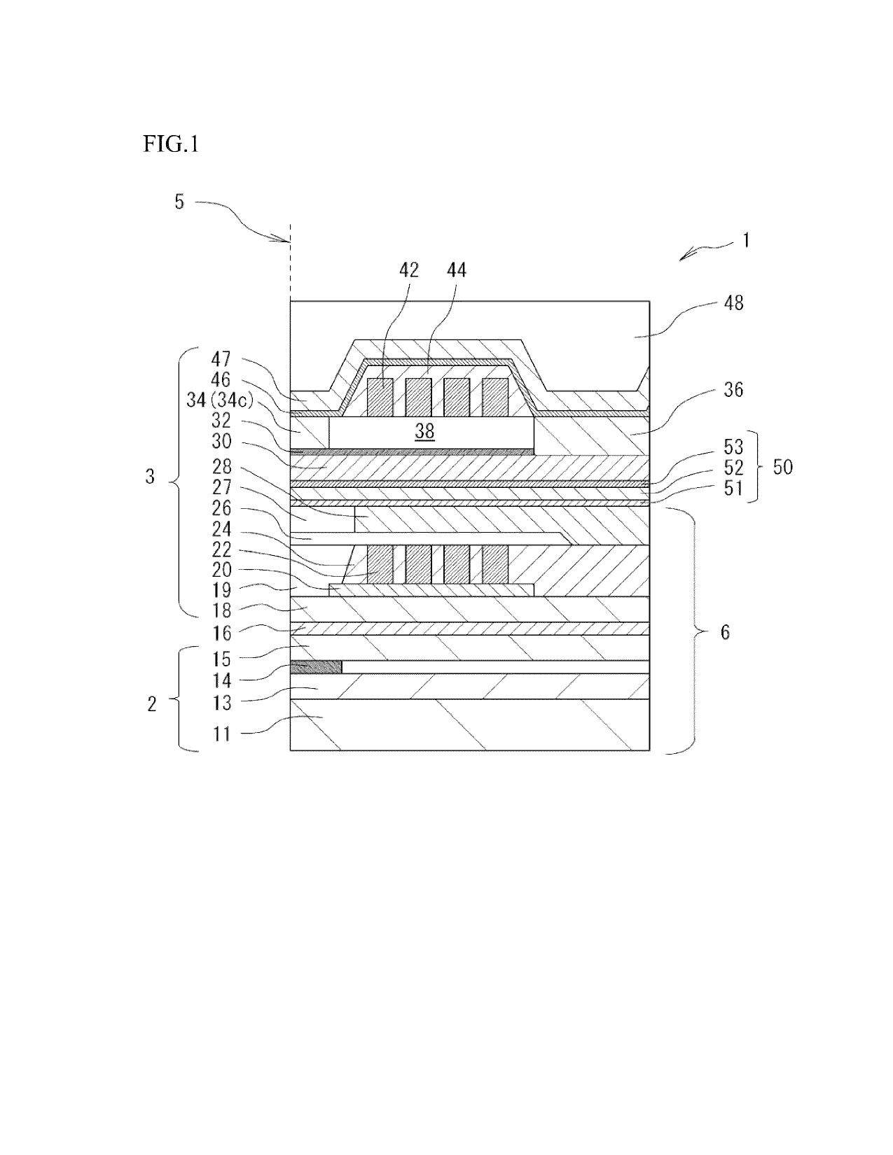

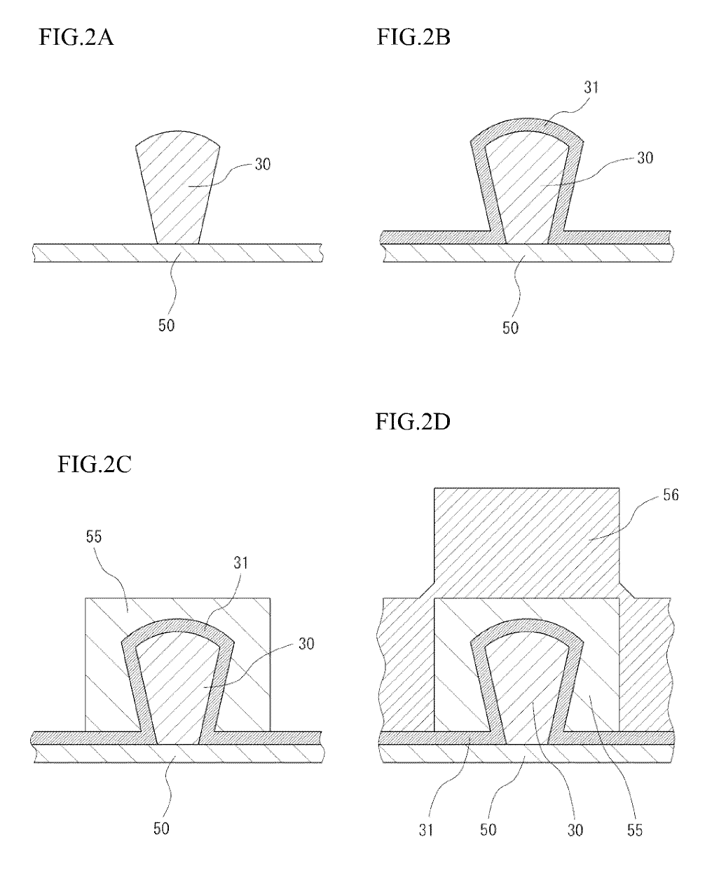

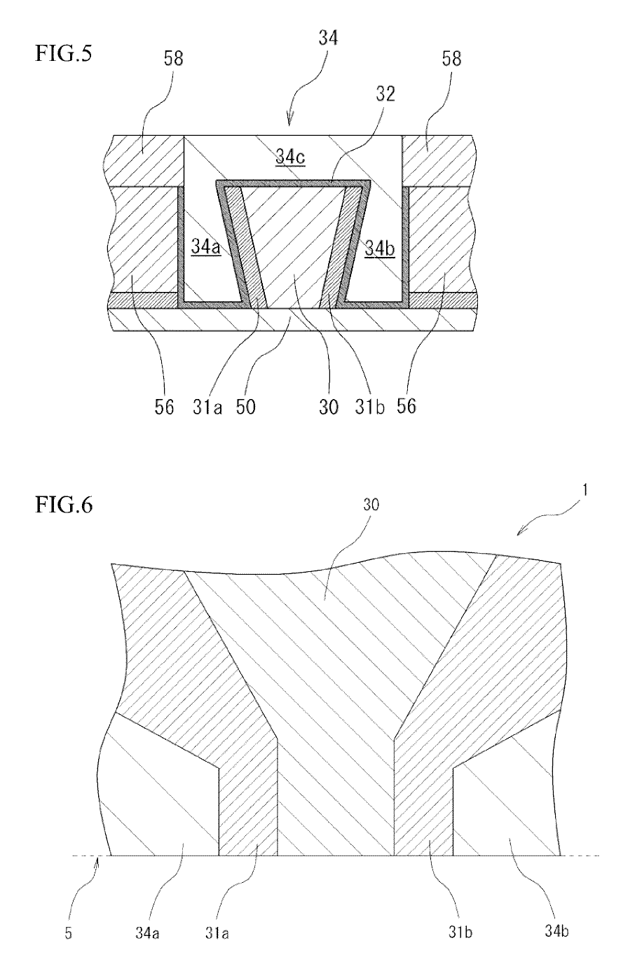

A preferred embodiment of the present invention will now be described in detail with reference to the drawings. FIG. 1 is a schematic diagram (a cross-sectional view in a head height direction) showing one example of the construction of a thin-film magnetic head 1 manufactured by a method of manufacturing a thin-film magnetic head according to an embodiment of the present invention. FIGS. 2A to 5 are diagrams useful in explaining the method of manufacturing the thin-film magnetic head 1. FIG. 6 is a plan view (schematic diagram) useful in explaining the form of side shields of a thin-film magnetic head according to an embodiment of the present invention.

The thin-film magnetic head 1 for the present invention is a thin-film magnetic head equipped with a recording head unit 3 that writes a magnetic signal onto a magnetic recording medium such as a hard disk.

After the recording head unit 3 has been formed by laminating layers and an air bearing surface 5 has been provided on a surface that is perpendicular to the surfaces of the laminated layers to construct a head slider, recording is carried out by having the air bearing surface 5 cause the recording head unit 3 to float above a rotating magnetic recording medium.

The construction of the thin-film magnetic head 1 will now be described by way of an example of a thin-film magnetic head for perpendicular recording. However, this is merely one illustrative example, and the present invention is not limited to such construction.

As one embodiment of the present invention, as shown in FIG. 1 the thin-film magnetic head 1 is constructed as a composite thin-film magnetic head equipped with a reproduction head unit 2 and the recording head unit 3. Note that the present invention is not limited to being applied to such composite thin-film magnetic head.

Here, although the reference numeral 5 in FIG. 1 shows the air-bearing surface, since the air-bearing surface is actually formed by carrying out a lapping process after the laminating process described below has been completed, at the intermediate stage in the manufacturing of the thin-film magnetic head 1 described below, reference numeral 5 more correctly designates a position where the air-bearing surface will later be formed.

First, in more detail, the reproduction head unit 2 has a multilayer structure formed by laminating a lower shield layer 13, a magnetoresistance effect reproduction element 14, and an upper shield layer 15 on a substrate 11. As one example, the substrate 11 is constructed using an insulating material such as Al₂O₃—TiC.

Here, the magnetoresistance effect reproduction element 14 is constructed using a TMR element or a GMR element, for example. It is possible to use a variety of constructions as the film construction of the TMR element and the GMR element.

The lower shield layer 13 is also constructed using NiFe or the like that is a magnetic material (soft magnetic material). The upper shield layer 15 is also constructed using a magnetic material (soft magnetic material) such as NiFe in the same way as the lower shield layer 13.

In the present embodiment, a magnetic separation layer 16 composed of an insulating material is provided on the upper layer of the upper shield layer 15, and the recording head unit 3 is provided thereupon.

Next, the construction of the recording head unit 3 will be described in more detail. The recording head unit 3 includes a lower return yoke 18 composed of a magnetic material such as NiFe. A coil lower insulating layer 20 is provided on the lower return yoke 18. The coil lower insulating layer 20 is constructed of an insulating material such as Al₂O₃, for example. Here, reference numeral 19 also designates an insulating layer composed of an insulating material such as Al₂O₃.

Note that it is possible to use a construction where a DFH (Dynamic Flying Height) heater (not shown) for intentionally controlling the amount by which the recording head unit 3 protrudes in the direction of the air bearing surface is provided in the coil lower insulating layer 20 for example.

A lower coil layer 22 is formed in a flat spiral on the coil lower insulating layer 20 using copper as a conductive material, for example.

A lower coil insulating layer 24 is also provided between the turns and above the lower coil layer 22. The lower coil insulating layer 24 is composed of an insulating material such as Al₂O₃.

A supplementary magnetic pole 28 is provided on the lower coil layer 22 and the lower coil insulating layer 24 which are partly covered by an insulating layer 26. Note that as examples, the supplementary magnetic pole 28 may be composed of a magnetic material such as NiFe and the insulating layer 26 may be composed of an insulating material such as Al₂O₃. Reference numeral 27 refers to an insulating layer that is composed of an insulating material such as Al₂O₃.

In the present embodiment, the laminated structure composed of the layers from the substrate 11 to the layer composed of the insulating layer 27 and the supplementary magnetic pole 28 are referred to as the “base” (indicated by reference numeral 6 in the drawings).

Note that it is possible to use a variety of constructions as the base 6, and the construction described above is merely one illustrative example.

A main magnetic pole 30 is provided via a plating base 50 on the base 6. As one example, the main magnetic pole 30 is formed by laminating two magnetic layers in the thickness direction, where the upper magnetic layer is formed using FeCo (for example, 69.5% FeCo) that is a high Bs (i.e., saturation magnetic flux density) material and the lower magnetic layer is formed using NiFe (for example, 90% NiFe) that is a low Bs material. By using this construction, it is possible to eliminate the problem of pole erasing that occurs due to remnant magnetism of the main magnetic pole and therefore record with a higher density. Note that the laminated structure of the main magnetic pole 30 is not limited to the two-layer structure described above.

On the other hand, as one example the plating base 50 has a three-layer construction composed in order from the bottom of a Ta (tantalum) layer 50, an Ru (ruthenium) layer 52, and a NiFe layer 53.

A trailing gap layer 32 and a connecting portion 36 are provided on the main magnetic pole 30 and a trailing shield 34 (34c) is provided on part of the trailing gap layer 32. As one example, the trailing gap layer 32 is composed of an insulating material such as Al₂O₃ and the trailing shield 34 (34c) and the connecting portion 36 are composed of a magnetic material such as NiFe.

Note that an insulating layer 38 is laminated using Al₂O₃ around the trailing shield 34 (34c) and the connecting portion 36. In the present embodiment, at this stage, the respective upper surfaces of the trailing shield 34 (34c), the connecting portion 36, and the insulating layer 38 are planarized so as to become flush.

In addition, an upper coil layer 42 is formed in a flat spiral on the insulating layer 38 using copper as a conductive material, for example.

An upper coil insulating layer 44 is also provided between the turns and above the upper coil layer 42. The upper coil insulating layer 44 is composed of an insulating material such as a resist.

An upper return yoke 47 is provided on the upper coil insulating layer 44. As one example, the upper return yoke 47 is constructed of a magnetic material such as NiFe.

An insulating layer 48 is laminated using Al₂O₃ on the upper return yoke 47.

Next, a method of manufacturing the thin-film magnetic head 1 according to the present embodiment will be described.

To summarize this method of manufacturing, after the reproduction head unit 2 has been formed, the magnetic separation layer 16 is provided and then the recording head unit 3 that has the construction described above is formed thereupon. This method will now be described starting from the characteristic steps in the present embodiment.

First, after the laminated structure up to the layer composed of the insulating layer 27 and the supplementary magnetic pole 28 (or in other words, the base 6) has been formed, the upper surfaces of the insulating layer 27 and the supplementary magnetic pole 28 are planarized by carrying out lapping for example so as to become continuous and flush. The main magnetic pole 30 is then formed on the base 6 via the plating base 50. The form (cross-sectional form) of an end portion of the main magnetic pole 30 on the air-bearing surface side is shown in FIG. 2A (note that the base 6 and the like are not shown in FIG. 2A).

Note that the main magnetic pole 30 is formed by a so-called “resist reflow process” where a resist is applied, exposed, developed, and then electroplating is carried out. Here, as one example, the plating base 50 is formed by laminating the Ta layer 51, the Ru layer 52, and the NiFe layer 53 in order from the bottom.

Next, a Ta layer 31, which forms a stopper layer for use in a CMP (Chemical Mechanical Polishing) process (a “first CMP process”) carried out as a later step, is sputtered so as to be formed on the main magnetic pole 30 and the plating base 50 (see FIG. 2B).

When doing so, the stopper layer 31 is formed so as to cover the main magnetic pole 30 and so that the thickness of the stopper layer 31 at positions on the respective sides of the main magnetic pole 30 is a predetermined side shield gap width (as one example, a thickness of around 100 nm on each side). That is, the stopper layer 31 is a layer that is constructed so that above the main magnetic pole 30, the stopper layer 31 functions as a stopper in a CMP process (before being removed) and on the sides of the main magnetic pole 30, the stopper layer 31 functions as the respective side shield gaps.

For the above reason, the stopper layer 31 is formed of a non-magnetic material that can be easily removed in a later step by dry etching using reactive gas (in the present embodiment, RIE (Reactive Ion Etching). As one example, aside from the tantalum (Ta) described above, a metal material such as ruthenium (Ru) could conceivably be used.

Next, as shown in FIG. 2C, a resist layer 55 is formed so as to cover the stopper layer 31 in the periphery of the main magnetic pole 30. As one example, it is possible to form the resist layer 55 using a typical resist material according to a well-known photolithography process.

At this time, the thickness of the resist layer 55 on both sides of the main magnetic pole 30, that is, the thickness in the track width direction (the left-right direction in FIG. 2C) is formed so as to be a predetermined side shield width. That is, the resist layer 55 acts so as to regulate the form of the side shields that will be formed by plating in a later process. In this way, the present embodiment is characterized in that instead of forming the side shields from the start, the resist layer 55 is used to temporarily regulate the form of the side shields and the side shields are then formed having removed the resist layer 55 (this will be described in detail later). Here, FIG. 6 (a schematic cross-sectional view) shows the form of such side shields 34a, 34b in plan view (in FIG. 6, a layer corresponding to reference numeral 32 is not shown).

According to this step, since it is possible to control the form (i.e., width) of the side shields by carrying out a photolithography process, and in particular by applying a resist and patterning the resist, it is easy to form the side shields with an optimal width and thickness to prevent side track erasing.

After this, as shown in FIG. 2D, an insulating layer 56 is constructed of an insulating material such as Al₂O₃ so as to cover the resist layer 55. Note that the insulating layer 56 only needs to be formed up to a predetermined height on the sides of the resist layer 55.

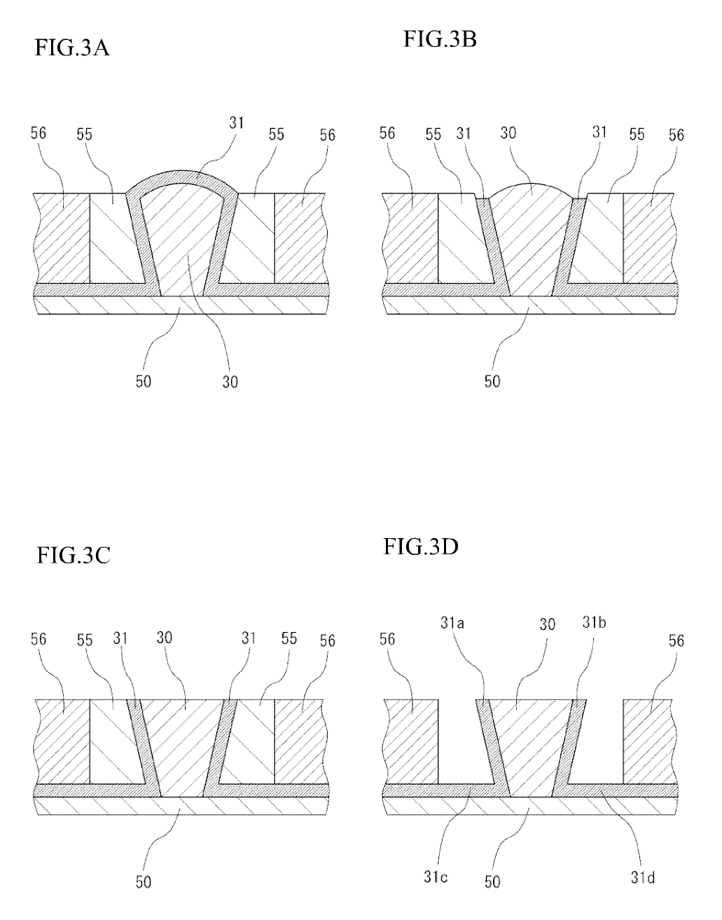

Next, as shown in FIG. 3A, by carrying out a CMP process (the “first CMP process”), the insulating layer 56 and the resist layer 55 that becomes exposed mid-process are lapped until the upper surface of the stopper layer 31 is exposed. At this time, since there is a large difference in the so-called “selection ratio” between the Ta that constructs the stopper layer 31 and the Al₂O₃ or the like that constructs the insulating layer 56, there is very little film thickness loss in the stopper layer 31 during the CMP process.

For the reason given above, the resist layer 55 is formed of a resist material that is capable of being lapped by a CMP process.

Next, as shown in FIG. 3B, by carrying out dry etching using reactive gas (for example, RIE: Reactive Ion Etching), the stopper layer 31 is removed until the upper surface of the main magnetic pole 30 becomes exposed. Note that as another example, dry etching may be carried out using ICP (Inductively Coupled Plasma).

When doing so, a fluorine-based reactive gas or a mixture of a fluorine-based reactive gas and Ar (argon) is used as the reactive gas. Here, CF₄ can be given as an example of the fluorine-based reactive gas, but C₂F₆, SF₆, or the like could conceivably be used instead.

In the present embodiment, a mixture of CF₄ and Ar is used. When only CF₄ is used, the etching rate of the stopper layer (Ta layer) 31 is increased, which makes it difficult to control the process, and by using the mixture of CF₄ and Ar, it is possible to improve the controllability. Also, when the etching rate is high, there is the possibility that the Ta layer 31 that forms the side shield gap on both sides of the main magnetic pole 30 will also become damaged, which can cause misshaping of the side shield gap at a later stage. Accordingly, it is favorable to carry out dry etching with a low etching rate by using the mixed gas.

Next, as shown in FIG. 3C, by carrying out another CMP process (the second CMP process), lapping is carried out until the upper surface of the main magnetic pole 30 is planarized. Note that the resist layer 55 and the insulating layer 56 are also lapped. As one example, the main magnetic pole 30 is formed with a height of 180 nm.

Here, as the process that planarizes the upper surface of the main magnetic pole 30, it would be possible to carry out dry etching (for example, so-called “ion milling”) instead of the CMP process. However, from the viewpoint of improving the precision of the planarized surface, the CMP process is favorable.

Next, as shown in FIG. 3D, a step that removes the resist layer 55 is carried out by an etching process.

As the etching process, a favorable method is selected in accordance with the material that composes the resist layer 55. As one example, plasma etching that uses oxygen (O₂) is used. Note that depending on the resist material, it would also be conceivable to use so-called wet-etching.

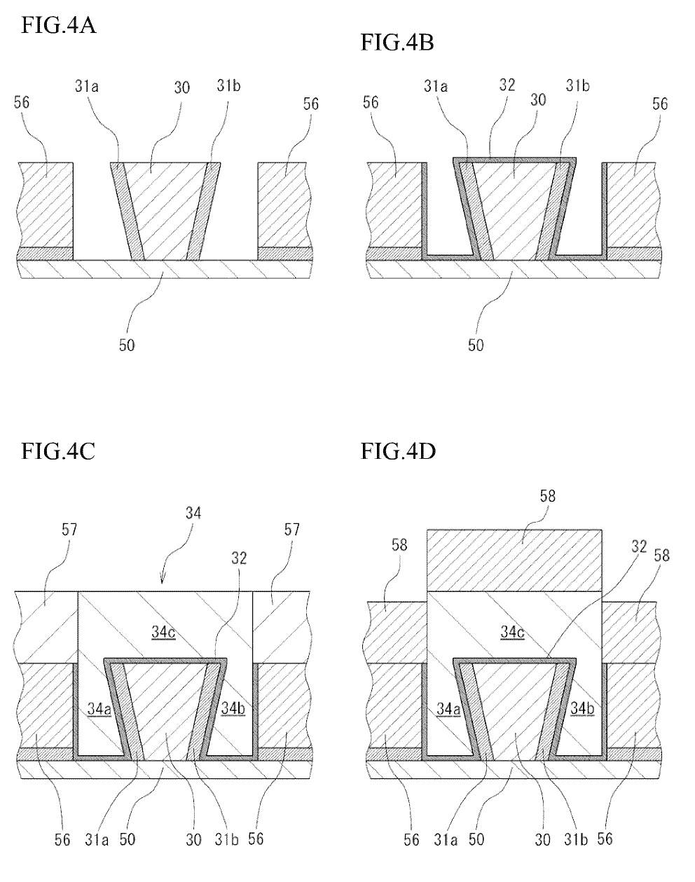

Next, as shown in FIG. 4A, dry etching is carried out using reactive gas to remove the stopper layer 31c, 31d that has become exposed due to the removal of the resist layer 55 in the previous step. Note that this dry etching process is carried out by a RIE process, for example, and since this is the same as in FIG. 3B, further description is omitted here.

As shown in FIG. 4A, the parts (designated by reference numerals 31a, 31B in FIG. 4A) of the layer formed as the stopper layer 31 that are positioned on the sides of the main magnetic pole 30 function as the side shield gap described above. Regarding the shape thereof, research conducted by the present inventors found that when, as shown in FIG. 3D, a construction is used where a bottom layer 31c, 31d (exposed parts) of the stopper layer that is continuous with the side shield gaps 31a, 31b is left on both sides of the main magnetic pole 30, this is disadvantageous from the viewpoint of preventing side erasing. In more detail, it was established that if the side shield length (i.e., the length in the recording track direction) is reduced, there is a reduction in the effect of suppressing magnetic fields that cause side erasing.

That is, forming the side shields with the appropriate length, or in other words, removing the bottom layer 31c, 31d of the stopper layer, is advantageous in preventing side erasing. However, since conventional methods carry out a process that first forms the stopper layer 31 and then forms the side shield layers on the bottom layer 31c, 31d of the stopper layer, it was not conventionally possible to remove the bottom layer 31c, 31d.

In the present embodiment, by carrying out a step of forming the resist layer 55 on the bottom layer 31c, 31d of the stopper layer to temporarily regulate the form of the side shields and then removing the resist layer 55, it is possible to regulate the form of the side shields and expose the bottom layer 31c, 31d provided below the resist layer 55. By doing so, it becomes possible to remove the bottom layers 31c, 31d and thereby form the side shield gaps 31a, 31b with the optimal form. As a result, it is possible to improve the ability of the thin-film magnetic head 1 to prevent side erasing.

Next, as shown in FIG. 4B, a step that forms the trailing gap layer 32 on the upper surface of the main magnetic pole 30 is formed by sputtering, for example. In the present embodiment, the trailing gap layer 32 is formed with a thickness of no greater than around 30 nm using Al₂O₃. Note that since the trailing gap layer 32 is also formed on regions aside from the upper surface of the main magnetic pole 30, unnecessary parts of the trailing gap layer 32 are removed by ion milling or the like.

Here, the formation precision of the trailing gap layer 32 greatly affects the recording characteristics (i.e., resolution). For this reason, in the present embodiment, the upper surface of the main magnetic pole 30 that forms a base surface for the trailing gap layer 32 is planarized with high precision by a CMP process (a “second CMP process”), and as a result, it is possible to produce the trailing gap layer 32 with a highly precise form (thickness).

In addition, when, as in the example of the conventional art, the trailing gap layer is deposited after the main magnetic pole has been produced in an inversely trapezoidal shape, it will be necessary to control the thickness of the trailing gap layer by etching, and therefore errors during depositing and errors during etching will synergistically occur. Even if both errors are small, this will still result in a large error and cause fluctuations in the form (thickness) of the trailing gap layer. In the present embodiment, since the distance from the main magnetic pole to the side shields and the trailing gap film thickness are separately controlled, the trailing gap layer can be formed by depositing only. As a result, it is possible to reduce fluctuations in the form (thickness) of the trailing gap layer.

As described above, it is possible to reduce the errors in the form (thickness) of the trailing gap layer 32, or in other words, to improve the precision of the form of the trailing gap.

Next, as shown in FIG. 4C, the side shields 34a, 34b and the trailing shield 34c (i.e., a plated layer 34) are integrally formed by plating via a plating base (not shown).

Note that the plated layer 34 is formed by carrying out a resist reflow process. Reference numeral 57 in FIG. 4C designates a resist mask that mainly functions to regulate the form of the trailing shield 34c.

After this, as shown in FIG. 4D, after the resist mask 57 has been removed, the insulating layer 58 composed of an insulating material such as A₂O₃ is formed so as to cover the plated layer 34. Note that the insulating layer 58 only needs to be formed up to a predetermined height on the sides of the plated layer 34.

Next, as shown in FIG. 5, a CMP process (the third CMP process) is carried out to lapp the upper surface of the trailing shield 34c so as to become a predetermined height.

After this, a step (not shown) that laminates well-known predetermined layers on the upper layer is carried out to finally form the thin-film magnetic head 1 shown in FIG. 1.

As described above, with the method of manufacturing a thin-film magnetic head according to the present embodiment, it is possible to planarize and form the upper surface of the main magnetic pole with high precision while using plating according to a resist reflow process as the method of forming the main magnetic pole. In addition, it is possible to form the side shields and the trailing shield that surround the main magnetic pole efficiently and with high precision. It is also possible to form the trailing gap with high precision.

In addition, by forming the main magnetic pole, the side shields, and the trailing shields with highly precise forms, it is possible to eliminate the problem of side erasing and to provide a thin-film magnetic head that is capable of recording with a higher density.

Note that although an example of a thin-film magnetic head for perpendicular recording has been described, the present invention is not limited to such.

What is claimed is:

1. A method of manufacturing a thin-film magnetic head, comprising:
a step of forming a recording magnetic pole by successively laminating thin films on a substrate;
a step of forming a stopper layer so as to cover the magnetic pole and so that a thickness of the stopper layer at positions on both sides of the magnetic pole is a predetermined side shield gap width;
a step of forming a resist layer so as to cover the stopper layer around the magnetic pole and so that a thickness of the resist layer at positions on both sides of the magnetic pole is a predetermined side shield width;
a step of forming an insulating layer so as to cover the resist layer;
a step of lapping the insulating layer and the resist layer by a CMP process until an upper surface of the stopper layer is exposed;
a step of removing the stopper layer by dry etching using reactive gas until an upper surface of the magnetic pole is exposed;
a step of lapping the upper surface of the magnetic pole by a CMP process until the upper surface is planarized;
a step of removing the resist layer by etching;
a step of removing the stopper layer by dry etching using reactive gas at positions where the stopper layer has become exposed due to removal of the resist layer;
a step of forming a trailing gap layer on the upper surface of the magnetic pole;
a step of forming a trailing shield on the upper surface of the magnetic pole and side shields on both sides of the magnetic pole by plating; and
a step of lapping by a CMP process until an upper surface of the trailing shield is a predetermined height.

2. A method of manufacturing a thin-film magnetic head according to claim 1,
wherein the stopper layer is constructed using one of tantalum and ruthenium.

3. A method of manufacturing a thin-film magnetic head according to claim 1,
wherein the dry etching using the reactive gas is carried out using a RIE process.

4. A method of manufacturing a thin-film magnetic head according to claim 2,
wherein the dry etching using the reactive gas is carried out using a RIE process.

5. A method of manufacturing a thin-film magnetic head according to claim 1,
wherein a plasma etching process that uses oxygen is used as the step of removing the resist layer by etching.

6. A method of manufacturing a thin-film magnetic head according to claim 2,
wherein a plasma etching process that uses oxygen is used as the step of removing the resist layer by etching.

7. A method of manufacturing a thin-film magnetic head according to claim 3,
wherein a plasma etching process that uses oxygen is used as the step of removing the resist layer by etching.

8. A method of manufacturing a thin-film magnetic head according to claim 4,
wherein a plasma etching process that uses oxygen is used as the step of removing the resist layer by etching.
